(19) United States
(12) Patent Application Publication
(10) Pub. No.: US 2017/0345043 A1
(43) Pub. Date: Nov. 30, 2017

(54) CONTACTLESS IDENTIFICATION AND LOCATING

(71) Applicant: NCR Corporation, Duluth, GA (US)

(72) Inventors: David Mayo, Cumming, GA (US); Matthew Phillip Kamp, Cumming, GA (US); Bill Ward, Duluth, GA (US)

(21) Appl. No.: 15/168,747

(22) Filed: May 31, 2016

(51) Int. Cl. G06Q 30/02; G06Q 20/20; G06Q 20/32; G06Q 50/12

(52) U.S. Cl. CPC G06Q 30/0226; G06Q 50/12; G06Q 20/204; G06Q 20/3224; G06Q 20/3278

(57) ABSTRACT

Various embodiments herein each include at least one of systems, devices, software, and methods for contactless identification and locating, such as with regard to restaurant customers having loyalty accounts and their locations within a restaurant. One such embodiment is in the form of a method that includes receiving, on a mobile device executing an app involved in processing a transaction, location input identifying a specific spot at a retail facility location where the transaction is occurring. The specific spot may be a seat number at a particular table. This method further includes receiving customer identifying input and transaction input with regard to a customer of the customer identifying input and transmitting data of the location input, customer identifying input, and the transaction input to another computing system for processing.

### BACKGROUND INFORMATION

In table service restaurants with loyalty programs, there are often multiple customers at a table with separate loyalty accounts. The first step for a server is to collect all the loyalty cards/numbers, take them to a back of house Point-Of-Sale (POS) system and enter them carefully and manually at each seat number on the table. This is a slow, error-prone process and often results in customers avoiding the loyalty program just to speed up service. Even restaurants enabled with the latest handheld POS technology, such as the ORDERMAN 7 solution available from NCR Corporation of Duluth, Ga. currently have the same problem. Various embodiments herein address such issues, and others, to create seamless experiences for customer, wait staff, and restaurants.

### SUMMARY

Various embodiments herein each include at least one of systems, devices, software, and methods for contactless identification and locating, such as with regard to restaurant customers having loyalty accounts and their locations within a restaurant.

One such embodiment is in the form of a method that includes receiving, on a mobile device executing an app involved in processing a transaction, location input identifying a specific spot at a retail facility location where the transaction is occurring. The specific spot may be a seat number at a particular table. This method further includes receiving customer identifying input and transaction input with regard to a customer of the customer identifying input and transmitting data of the location input, customer identifying input, and the transaction input to another computing system for processing.

Another method embodiment includes receiving order input within a mobile device for each of at least two customers located at a table within a restaurant. Further, for each of the at least two customers, this method includes electronically receiving customer identifying data and seat location data identifying a location of the respective customer at the table. This method may then transmit data of the order input, the customer identifying data, and the location data for each of the at least two customers to another computing system for processing.

A further embodiment is in the form of a handheld computing device, such as a smartphone, handheld computer, tablet, smartwatch, and the like. The handheld computing device typically includes a display, an input device, a wireless network interface device, at least one processor, and at least one memory device. The at least one memory device stores instructions executable by the at least one processor to perform data processing activities. The data processing activities may include receiving location input identifying a specific spot at a retail facility location where the transaction is occurring and receiving customer identifying input and transaction input with regard to a customer of the customer identifying input. The data processing activities may further include transmitting, via the at least one wireless network interface device, data of the location input, customer identifying input, and the transaction input to another computing system for processing.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, devices, software, and methods for contactless identification and locating, such as with regard to restaurant customers having loyalty accounts and their locations within a restaurant. In one embodiment, multiple restaurant customers each having established a loyalty account with the restaurant are in a single dining party at a single table within the restaurant. Each customer plans to pay their own bill. As part of having a loyalty account with the restaurant, each customer possesses a mechanism by which they can electronically identified by a handheld computing device carried by wait staff. The mechanism allowing for electronic identification of the customer may be a scanable code, such as a barcode, or a Radio Frequency Identification (RFID) tag. In such instances, the handheld computing device carried by wait staff includes one or both of a camera and software to read the barcode and an RFID tag reader. The mechanism allowing for electronic identification of the customer may be a code transmitted by a radio transceiver device within a smartphone or other mobile device of the customer, such as a Near Field Communication (NFC) transceiver device. In such embodiments, the handheld computing device carried by wait staff includes an NFC transceiver device to receive the NFC signals.

Regardless of the mechanism utilized in the particular embodiment by a customer, whether one or more options are offered by the restaurant operator, each customer will provide their identification item for acquisition by wait staff. The customer identifier typically includes a unique identifier that is known in a loyalty or customer system of the restaurant operator or by a third-party providing loyalty services thereto. The wait staff may then identify the table where the customers are seated and a seat position at that table for each respective customer as input within the handheld computing device. Order data may also be input and associated with each individual. Subsequently, when ordered items and bills are to be provided to the customers, each customer will receive their ordered items or bill directly to the location where seated and any loyalty benefits will automatically be attributed to the proper customer. These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

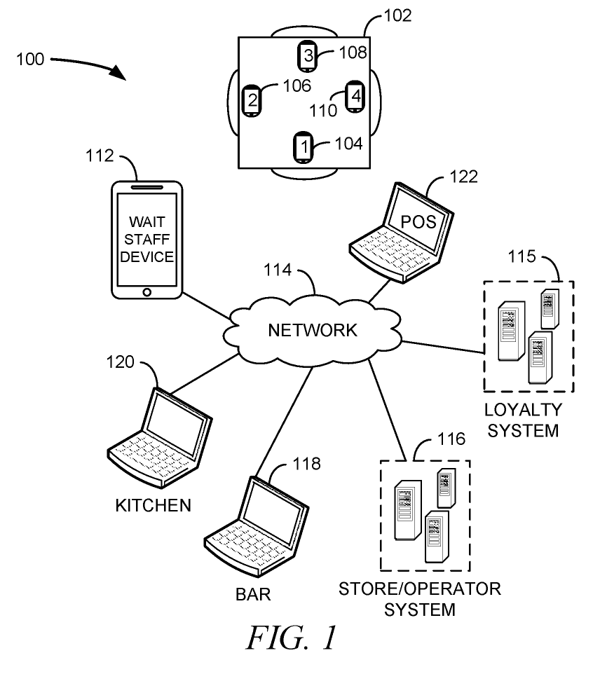

FIG. 1 is a logical block diagram of a system 100, according to an example embodiment. The system 100, as illustrated, includes a table 102 where restaurant customers may be seated. Although only a single table 102 is illustrated, the embodiments described, illustrated, and claimed herein are equally applicable to restaurants where multiple tables are present. The table 102 is therefore illustrated as a single table for the sake of brevity and to avoid complex illustrations that would not aid in deeper understanding of the embodiments herein.

The table 102 includes four seating locations. Other table sizes and seat numbers are also relevant hereto. Each seating position is numbered 1, 2, 3, and 4. The table 102 is also uniquely identified within a restaurant, although that identification is not illustrated. Four customers may be seated that the table 102 and each possesses a smartphone 104, 106, 108, 110 that is utilized to provide a customer loyalty account identifier of each respective customer for reading by a wait staff handheld computing device 112.

The identifier may be provided as an NFC code transmitted by an NFC transceiver device of a respective smartphone 104, 106, 108, 110. A customer loyalty identifier is a unique value assigned to a customer that is known in a loyalty system 115 that operates on a network to track customer loyalty, provide incentives and marketing, store customer preferences and pre-staged orders, and the like. In some embodiments, rather than in an NFC transmission, the identifier may be provided as an RFID tag within a loyalty card or sticker provided to a customer, a bar code on a sticker or as may be presented on a customer's smartphone 104, 106, 108, 110, and the like. Regardless of the form in which the customer loyalty identifier is tendered, wait staff, utilizing the wait staff device 112, may tap a customer's smartphone 104, 106, 108, 110, hold an RFID reader of the wait staff device 112 close to an item embedded with an RFID tag or to which an RFID tag is affixed, or scan a barcode presented on a smartphone display 104, 106, 108, 110 or as printed on a card or sticker affixed to another item.

Note as well that in some embodiments, each customer may set preferences, a standing drink order, a pre-staged dining order, and the like in the loyalty system 115 by interacting with the loyalty system 115 via a website or an app that executes on their respective smartphones 104, 106, 108, 110 or other mobile device. Thus, when a customer's loyalty identifier is acquired by the wait staff device 112 and the wait staff inputs data identifying the table 102 and a seat number where the customer is seated, the loyalty system 115 may be queried to obtain one or more of customer identifying data, offer data for the specific customer, a points balance, a standing drink order, and any pre-staged orders. When a standing drink order or a pre-staged order is obtained, the wait staff device 112 may forward that data to one or both of a bar terminal 118 and a kitchen terminal 120 to have the item(s) prepared and delivered to the customer at the table 102 in their specific seat location.

Similar to table service restaurants, the same customer loyalty identifier embodiments may be applied in other restaurant and retail contexts. For example, in a drive-thru or quick service restaurant context, a scan point may be provided that is associated with a known location, such as a delivery point. Upon tendering a customer loyalty identifier, a customer account of which may also be associated with a payment account or digital wallet within the loyalty system 115, a pre-staged or standing order may be transmitted to the kitchen terminal 120. Once the order is prepared, the order will be delivered to the know location.

In a retail context, the order may be an order placed online or via a mobile device app. Once the customer loyalty identifier is tendered at the scan point, items of the order may be retrieved by retail outlet staff and delivered to the waiting customer at the delivery point.

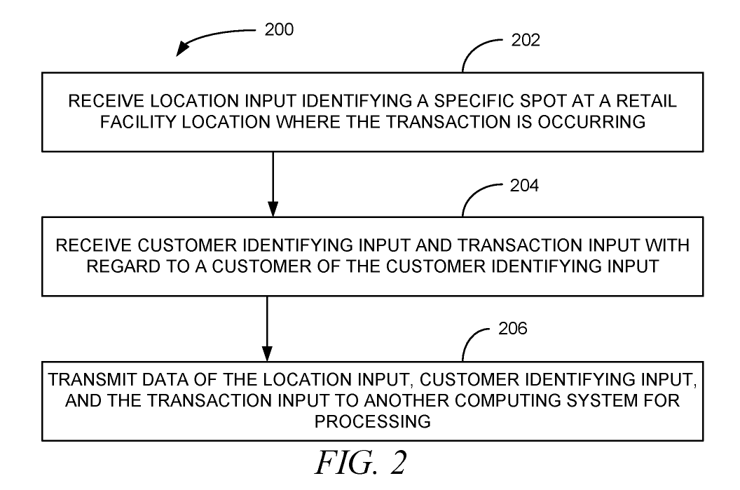

FIG. 2 is a block flow diagram of a method 200, according to an example embodiment. The method 200 is an example of a method that may be performed on a wait staff computing device, such as wait staff device 112. The method 200 includes receiving 202, on a mobile device executing an app involved in processing a transaction, location input identifying a specific spot at a retail facility location where the transaction is occurring. The method 200 further includes receiving 204 customer identifying input and transaction input with regard to a customer of the customer identifying input. The method 200 may then transmit 206 data of the location input, customer identifying input, and the transaction input to another computing system for processing.

In some embodiments of the method 200, the customer identifying input is a customer loyalty account identifier. Further, the retail facility may be a restaurant, the retail facility location may be a specific table within the restaurant, and the specific spot at the retail facility location may be a specific seat at the specific table within the restaurant. Further, the received 204 transaction input may include restaurant food order input which may be received for each of a plurality of specific seats at the specific table with regard to multiple customer loyalty account identifiers or a single customer loyalty account identifier for all seats.

In one such embodiment, a plurality of customer loyalty account identifiers are received during a single session at the specific table within the restaurant where a bill for the single session to be generated for each customer loyalty account identifier with regard to items received as transaction input with regard to the respective customer loyalty account identifier. For example, where there are four individuals seated at a table and each provides a customer loyalty identifier, four bills will be generated.

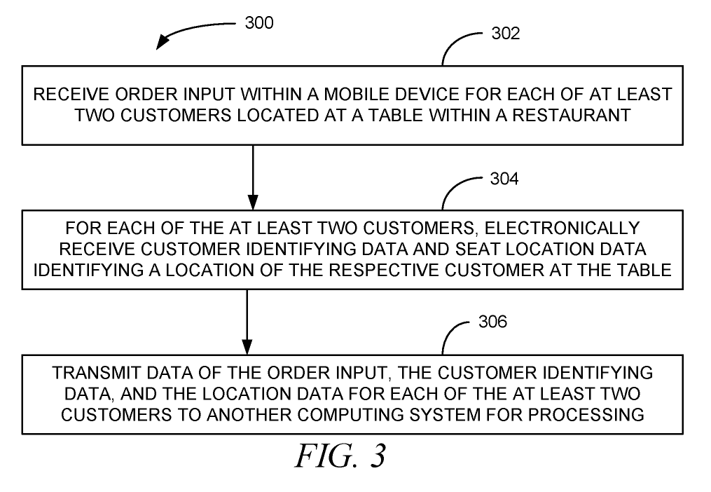

FIG. 3 is a block flow diagram of a method 300, according to an example embodiment. The method 300 is another example of a method that may be performed on a wait staff computing device, such as wait staff device 112.

The method 300 includes receiving 302 order input within a mobile device for each of at least two customers located at a table within a restaurant. For each of the at least two customers, the method 300 includes electronically receiving customer identifying data and seat location data identifying a location of the respective customer at the table and transmitting 306 data of the order input, the customer identifying data, and the location data for each of the at least two customers to another computing system for processing. In some such embodiments, the computing system to which the data is transmitted 306 is a restaurant computing system that routes the data to a kitchen for the customer orders to be prepared and at least a portion of the data to a customer loyalty process that tracks customer activity.

In some such embodiments of the method 300, electronically receiving 304 customer identifying data includes receiving a customer loyalty account number via one of an NFC device of the mobile device, an RFID tag reader of the mobile device, and a process that executes on the mobile device to read data from a barcode image captured by an imaging device of the mobile device.

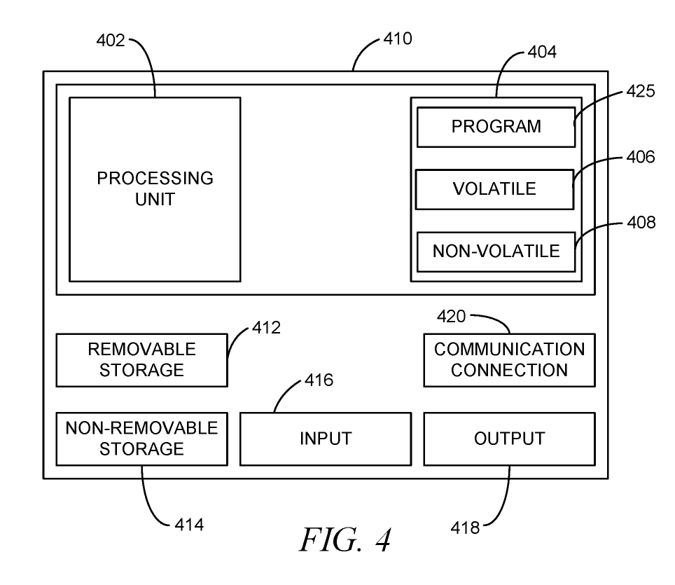

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, on a mobile device executing an app involved in processing a transaction, location input identifying a specific spot at a retail facility location where the transaction is occurring;
receiving customer identifying input and transaction input with regard to a customer of the customer identifying input; and
transmitting data of the location input, customer identifying input, and the transaction input to another computing system for processing.

2. The method of claim 1, wherein the customer identifying input is a customer loyalty account identifier.

3. The method of claim 2, wherein the retail facility is a restaurant, the retail facility location is a specific table within the restaurant, and the specific spot at the retail facility location is a specific seat at the specific table within the restaurant.

4. The method of claim 3, wherein the transaction input includes restaurant food order input.

5. The method of claim 4, wherein transaction input is received for a plurality of specific seats at the specific table with regard to a single customer loyalty account identifier.

6. The method of claim 5, wherein a plurality of customer loyalty account identifiers are received during a single session at the specific table within the restaurant, a bill to be generated for each customer loyalty account identifier with regard to items received as transaction input with regard to the respective customer loyalty account identifier.

7. The method of claim 3, wherein the mobile device executing the app involved in processing the transaction includes a radio transceiver device that receives the customer identifying input.

8. The method of claim 7, wherein the customer identifying input is received by the mobile device by placing the mobile device in proximity to an item of a specific item of a customer of the customer identifying input.

9. The method of claim 8, wherein the radio transceiver device is a Near Field Communication (NFC) device and the specific item is a mobile device of the customer that transmits an NFC radio signal encoded with the customer identifying input.

10. The method of claim 8, wherein the radio transceiver device is a Radio Frequency Identification (RFID) reader and the specific item is an RFID tag.

11. The method of claim 3, wherein the mobile device executing the app involved in processing the transaction includes an imaging device that captures images of barcodes encoded with the customer identifying input, a captured image processed by the app on the mobile device to obtain the customer identifying input.

12. A method comprising:
receiving order input within a mobile device for each of at least two customers located at a table within a restaurant;
for each of the at least two customers, electronically receiving customer identifying data and seat location data identifying a location of the respective customer at the table;
transmitting data of the order input, the customer identifying data, and the location data for each of the at least two customers to another computing system for processing.

13. The method of claim 12, wherein the another computing system to which the data is transmitted is a restaurant computing system that routes the data to a kitchen for the customer orders to be prepared and at least a portion of the data to a customer loyalty process that tracks customer activity.

14. The method of claim 12, wherein electronically receiving customer identifying data includes receiving a customer loyalty account number via one of a Near Field Communication (NFC) device of the mobile device, a Radio Frequency Identification (RFID) tag reader of the mobile device, and a process that executes on the mobile device to read data from a barcode image captured by an imaging device of the mobile device.

15. A handheld computing device comprising:
a display;
an input device;
a wireless network interface device;
at least one processor; and
at least one memory device storing instructions executable by the at least one processor to perform data processing activities comprising:
receiving location input identifying a specific spot at a retail facility location where the transaction is occurring;
receiving customer identifying input and transaction input with regard to a customer of the customer identifying input; and
transmitting, via the at least one wireless network interface device, data of the location input, customer identifying input, and the transaction input to another computing system for processing.

16. The handheld computing device of claim 15, wherein:
the customer identifying input is a customer loyalty account identifier;
the retail facility is a restaurant;
the retail facility location is a specific table within the restaurant; and
the specific spot at the retail facility location is a specific seat at the specific table within the restaurant.

17. The handheld computing device of claim 16, wherein:
the transaction input includes restaurant food order input;
transaction input is received for a plurality of specific seats at the specific table with regard to a single customer loyalty account identifier; and
a plurality of customer loyalty account identifiers are received during a single session at the specific table within the restaurant, a bill to be generated for each customer loyalty account identifier with regard to items received as transaction input with regard to the respective customer loyalty account identifier.

18. The handheld computing device of claim 16, further comprising:
at least one of:
a Near Field Communication (NFC) device that receives an NFC radio signal encoded with the customer identifying input as transmitted by a customer mobile device;
a Radio Frequency Identification (RFID) reader to read an RFID identifier that is a customer identifier; and
an imaging device that captures images of barcodes encoded with the customer identifying input, a captured image processed to obtain the customer identifying input.
